(19) United States
(12) Patent Application Publication
(10) Pub. No.: US 2017/0225488 A1
(43) Pub. Date: Aug. 10, 2017

(54) RECORDING METHOD AND RECORDING DEVICE

(71) Applicants: Satoshi ARAI, Shizuoka (JP); Yoshihiko HOTTA, Shizuoka (JP); Kazuyuki UETAKE, Shizuoka (JP); Ichiro SAWAMURA, Shizuoka (JP); Tomomi ISHIMI, Shizuoka (JP); Yasuroh YOKOTA, Shizuoka (JP)

(72) Inventors: Satoshi ARAI, Shizuoka (JP); Yoshihiko HOTTA, Shizuoka (JP); Kazuyuki UETAKE, Shizuoka (JP); Ichiro SAWAMURA, Shizuoka (JP); Tomomi ISHIMI, Shizuoka (JP); Yasuroh YOKOTA, Shizuoka (JP)

(73) Assignee: RICOH COMPANY, LTD., Tokyo (JP)

(21) Appl. No.: 15/424,696

(22) Filed: Feb. 3, 2017

(30) Foreign Application Priority Data
Feb. 5, 2016 (JP) 2016-021341
Jan. 27, 2017 (JP) 2017-013649

(51) Int. Cl. B41J 2/46; B41J 2/455

(52) U.S. Cl. CPC B41J 2/46; B41J 2/455

(57) ABSTRACT

A recording method including: emitting laser light from optical-fiber-array to record image of writing units with moving recording target and the optical fiber array relatively using recording device including laser light-emitting elements, and emitting unit including the optical-fiber-array, where optical fibers to guide laser light emitted from the laser light-emitting elements are aligned, wherein, where the laser light is applied from the optical fibers adjacent to each other in main-scanning direction to the recording target to record solid image of the writing units at least partially overlapped to each other in the main-scanning direction, recording is performed by reducing irradiation energy of the laser light for recording the writing units other than both edges of the solid image relative to the main-scanning direction, compared to irradiation energy of the laser light for recording the writing units present at the both edges of the solid image.

### CROSS-REFERENCE TO RELATED APPLICATIONS

The present application claims priority under 35 U.S.C. §119 to Japanese Patent Application No. 2016-021341, filed Feb. 5, 2016 and Japanese Patent Application No. 2017-013649, filed Jan. 27, 2017. The contents of which are incorporated herein by reference in their entirety.

### BACKGROUND OF THE INVENTION

Field of the Invention

The present disclosure relates to a recording method and a recording device.

Description of the Related Art

As a recording method for performing recording on thermosensitive recording media with a change in hue or reflectance caused by heating, for example, contact recording methods, such as use of heat stamps or thermal heads, have been generally known. Among the above-mentioned examples, thermal heads have been most commonly used.

In a recording method using the thermal head, the thermal head is pressed against a thermosensitive recording medium in order to achieve sufficient heat conductivity. Therefore, print missing occurs due to deterioration of a surface of a thermal head caused by dirt or foreign matter deposited on a surface of the thermosensitive recording medium. As a result, maintenance or replacement of the thermal head may be required.

Meanwhile, as method for recording in non-contact manner, there are recording methods using laser. As the recording methods using laser, typical is a method where one laser beam is scanned by a galvanometer mirror to perform recording. The above-described recording method however has a problem that a recording time is prolonged, as a quantity of information of a recording image increases. In order to solve the problem, for example, proposed is an image-replacement method where a reversible thermosensitive recording medium is exposed to a laser beam set to satisfy the desired relationship using a laser array exposure unit, in which a plurality of lasers each independently driven are aligned in a direction orthogonal to a moving direction of the reversible thermosensitive recording medium (see, for example, Japanese Unexamined Patent Application Publication No. 2010-52350).

### SUMMARY OF THE INVENTION

According to one aspect of the present disclosure, a recording method includes emitting laser light from an optical fiber array to record an image formed of writing units with moving a recording target and the optical fiber array relatively using a recording device including a plurality of laser light-emitting elements, and an emitting unit including the optical fiber array, in which a plurality of optical fibers configured to guide laser light emitted from the laser light-emitting elements are aligned. In a case where the laser light is applied from the optical fibers adjacent to each other in the main-scanning direction to the recording target to record a solid image formed of the writing units at least partially overlapped to each other in the main-scanning direction, recording is performed by reducing irradiation energy of the laser light for recording the writing units other than both edges of the solid image relative to the main-scanning direction, compared to irradiation energy of the laser light for recording the writing units present at the both edges of the solid image.

### BRIEF DESCRIPTION OF THE DRAWINGS

FIG. 1 is a schematic view illustrating one example of a recording device of the present disclosure including an optical fiber array;

FIG. 2 is a partially-omitted enlarged view of the optical fiber array of FIG. 1;

FIG. 3 is an enlarged partial view of the optical fiber of FIG. 2;

FIG. 4A is a view illustrating one example of an alignment state of the array head;

FIG. 4B is a view illustrating another example of an alignment state of the array head;

FIG. 4C is a view illustrating another example of an alignment state of the array head;

FIG. 4D is a view illustrating another example of an alignment state of the array head;

FIG. 5 is an explanatory view illustrating one example of a density distribution of a writing unit according to the recording method of the present disclosure;

FIG. 6 is an explanatory view illustrating one example of a density distribution of a solid image according a general recording method in the art;

FIG. 7 is an explanatory view illustrating one example of a density distribution of a solid image according to the recording method of the present disclosure;

FIG. 8 is an explanatory view illustrating another example of a density distribution of a solid image according to the recording method of the present disclosure;

FIG. 9 is an explanatory view illustrating a measuring method of a line width of overlapped writing units;

FIG. 10 is a view for explaining a definition of an oval of the writing unit; and

FIG. 11 is a schematic view for depicting definitions of a line width and an image.

### DESCRIPTION OF THE EMBODIMENTS

### (Recording Method and Recording Device)

A recording method of the present disclosure includes emitting laser light from an optical fiber array to record an image formed of writing units with moving a recording target and the optical fiber array relatively using a recording device including a plurality of laser light-emitting elements, and an emitting unit including the optical fiber array, in which a plurality of optical fibers configured to guide laser light emitted from the laser light-emitting elements are aligned. In a case where the laser light is applied from the optical fibers adjacent to each other in the main-scanning direction to the recording target to record a solid image formed of the writing units at least partially overlapped to each other in the main-scanning direction, recording is performed by reducing irradiation energy of the laser light for recording the writing units other than both edges of the solid image relative to the main-scanning direction, compared to irradiation energy of the laser light for recording the writing units present at the both edges of the solid image.

A recording device of the present invention includes a plurality of laser light-emitting elements, and an emitting unit including an optical fiber array, in which a plurality of optical fibers configured to guide laser light emitted from the laser light-emitting elements are aligned. The recording device is configured to apply laser light emitted from the optical fiber array with moving a recording target and the optical fiber array relatively, to record an image formed of writing units. In a case where the laser light is applied from the optical fibers adjacent to each other in the main-scanning direction to the recording target to record a solid image formed of the writing units at least partially overlapped to each other in the main-scanning direction, recording is performed by reducing irradiation energy of the laser light for recording the writing units other than both edges of the solid image relative to the main-scanning direction, compared to irradiation energy of the laser light for recording the writing units present at the both edges of the solid image.

The present disclosure has an object to provide a recording method which can record a solid image having less density unevenness, when recording is performed using optical fiber arrays.

The present disclosure can provide a recording method which can record a solid image having less density unevenness, when recording is performed using optical fiber arrays.

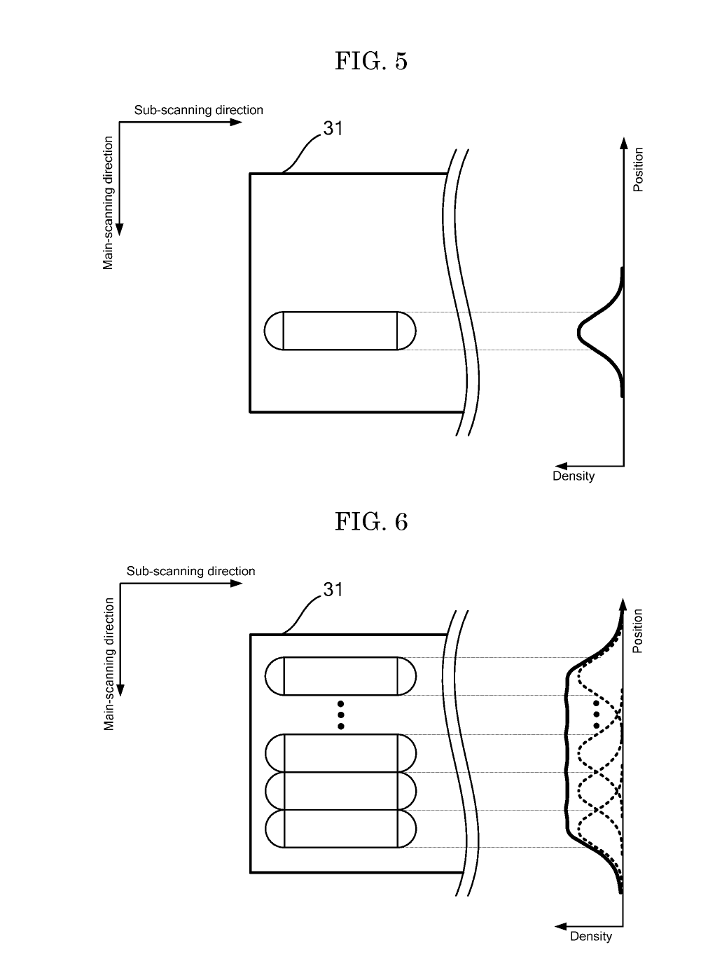

The recording device and recording method of the present disclosure are accomplished based on the following finding. In a case where the solid image is recorded, among the writing units constituting the solid image, density of the writing units at both edges along the main-scanning direction is different from density of the writing units other than the both edges, and therefore density unevenness is caused. The density unevenness of the solid image caused when the solid image is recorded using the optical fiber array is described with reference to FIGS. 5 and 6.

There are two scanning directions of the laser light, a main-scanning direction and a sub-scanning direction. The main-scanning direction and the sub-scanning direction are orthogonal to each other.

The main-scanning direction is a direction along which a plurality of the optical fibers are aligned.

The sub-scanning direction is a direction along which the recording target is moved relative to the optical fiber array.

Since an image is recorded on the recording target by moving the recording target relative to the optical fiber array, the optical fiber array may travel relatively to recording target, or the recording target may travel relative to the optical fiber array.

FIG. 5 is an explanatory view illustrating one example of a density distribution when one writing unit is recorded. FIG. 6 is an explanatory view illustrating one example of a density distribution when a solid image formed of a plurality of writing units is recorded.

As illustrated in FIG. 5, in case the writing unit recorded alone without being surrounded by the writing units to be recorded, there is a distribution in the density of the writing units as illustrated at the right side of FIG. 5, when a light intensity distribution of a cross-section of the laser light applied to the recording target is a distribution where the center of the laser light is the strongest.

Meanwhile, in a recording method using the optical fiber array, an image is recorded at high speed. In the case where the solid image is recorded as illustrated in FIG. 6, therefore, the laser light is simultaneously emitted from a plurality of optical fibers adjacent to each other to the recording target, and a plurality of writing units are simultaneously recorded. In such a case, in order to record a solid image without density unevenness, a width of a writing unit recorded by each laser light beam along a main-scanning direction is appropriately controlled, the writing units are written not to form a gap between the adjacent writing units, and irradiation energy is controlled not to apply excessive energy due to excessive overlapping of writing units adjacent to each other. Moreover, the writing units at the both edges of the solid image has an adjacent writing unit only at a center direction of the solid image. Therefore, higher energy is used to record the writing units present at the both edges compared to the writing units other than the writing units at the both edges. When the recording energy identical to the recording energy used for writing units other than the writing units at the both edges is used for recording the writing units at the both edges, coloring is insufficient, and density unevenness or unclear outline may be caused. When large recording energy is applied in order to prevent density unevenness or unclear outline of the writing units at the both edges, on the other hand, an image may be expanded.

In a system where a solid image is formed on a medium, serving as a recording target, which changes color at a predetermined temperature or higher by simultaneously emitting laser light, cooling due to thermal diffusion occurs less at a center of the solid image compared to the both edges of the solid image and therefore the temperature at the center becomes excessive. The temperature can be maintained constant by applying the lower irradiation energy of laser light at the center compared to the both edges. In the present disclosure, therefore, laser irradiation power control for maintaining a uniform temperature at an image forming area is proposed.

Image formation using a thermal head has been difficult to perform on a thin film because the thin film is deformed by the heat transmitted by the contact with the thermal head. In a non-contact recording system using laser light according to the present disclosure, an image can be formed on a thin film having a thickness of 50 μm or less without any contact. However, deformation of the film is also caused in the non-contact system when the thin film is heated at uneven temperatures by the heat generated by the image formation to the thin film. In image formation on a thin film, therefore, uniform temperature-heating is particularly an important technique.

According to the recording method of the present disclosure, as illustrated in FIG. 7, in the case where the solid image is recorded using the optical fiber array, irradiation energy of laser light for recording writing units at both edges and writing units other than the both edges is appropriately controlled considering an influence of heat in advance, to prevent an increase in density in a colored area or expansion of an image. Therefore, a solid image having less density unevenness can be recorded.

According to the present disclosure, density of a solid image to be recorded becomes uniform, there is no density unevenness at the both edges, and the solid image can be recorded with intended density.

The density of the image can be measured, for example, by means of a microdensitometer (PDM-7, available from KONICA MINOLTA, INC.). Moreover, a line width of an overlapped writing unit in a main-scanning direction can be measured in the following manner. An image density is measured by means of the microdensitometer (slit width: 5 μm), and an average density is calculated from the maximum value and minimum value from the measured density values. An outline of the average density is determined, and the line width is determined by magnifying at 500 times.

As a standard of irradiation energy of laser light, the irradiation energy with which a pitch width of each of a plurality of laser irradiations is achieved at the position where image formation is performed is determined as 100%.

The maximum length A of the writing unit along the sub-scanning direction can be measured by means of a microdensitometer (PDM-7, available from KONICA MINOLTA, INC.). Specifically, image density is measured by a microdensitometer (slit width: 5 μm), and an average density is calculated from the maximum value and minimum value from the measured density values. An outline of the average density is determined, and the maximum length A is determined by magnifying at 500 times. In the same manner, the length W can be determined.

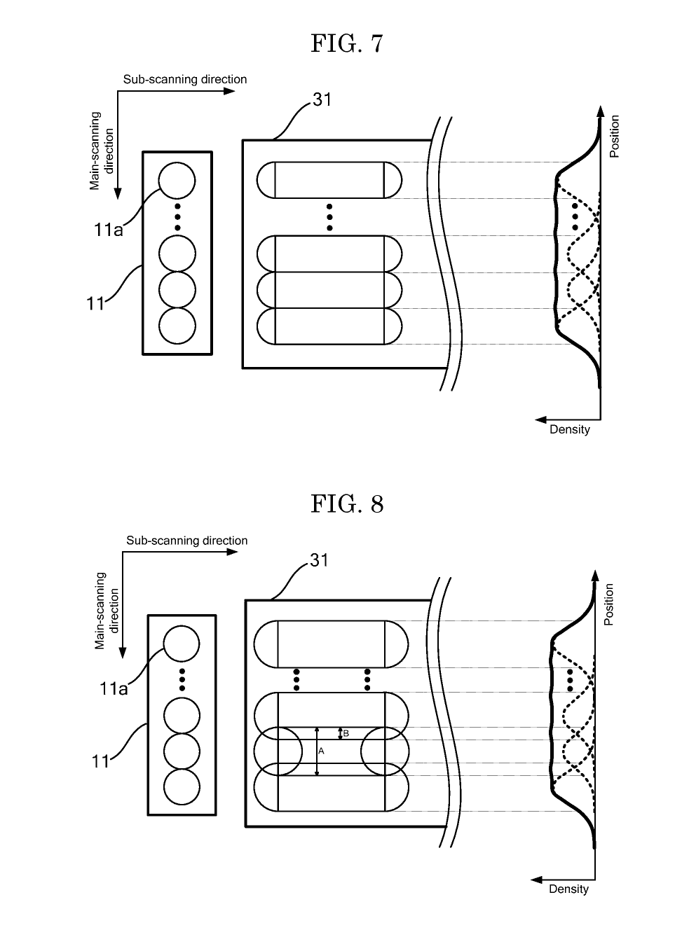

In order to form the solid image with the writing units, as illustrated at the left side of FIG. 8, a width of the writing unit in the main-scanning direction is controlled, and the writing units are preferably overlapped with each other along the main-scanning direction.

The following formula 1.0<Y<2.0 is preferably satisfied, where Y is a ratio (E1/E2) of irradiation energy Eo of laser light for recording writing units Do present at both edges of the solid image in the main-scanning direction to irradiation energy Ei of the laser light for recording writing units Di other than the both edges. When the following formula 1.0<Y is satisfied, a difference between the irradiation energy Eo of laser light for recording the writing units at the both edges of the solid image and the irradiation energy Ei of the laser light for recording the writing units of the solid image other than the both edges becomes large, and density unevenness of the solid image can be suppressed. Therefore, it is advantageous. When the following formula Y<2.0 is satisfied, occurrences of density unevenness or expansion of an image due to overheating of the both edges can be suppressed, and therefore it is advantageous.

The following formula 0<Xo<0.6 is preferably satisfied, where Xo is a ratio (Lo/Wi) of an overlapped width of the writing unit Di constituting the solid image, which is other than the both edges, adjacent to the both edges in the main-scanning direction to a line width Wi of the writing unit constituting the solid image, which is other than the both edges, adjacent to the both edges in the main-scanning direction. When the following formula 0<Xo<0.6 is satisfied, overlapping of the writing units at the both edges of the solid image and the writing units other than the both edges but adjacent to the both edges of the solid image becomes appropriate, and density unevenness between both groups of the writing units can be suppressed. Therefore, it is preferable.

The following formula 0<Xi≦0.4 is preferably satisfied, where Xi is a ratio (Li/Wi) of an overlapped width Li of the adjacent writing units Di constituting the solid image other than the both edges in the main-scanning direction to a line width Wi of the adjacent writing units Di constituting the solid image other than the both edges in the main-scanning direction. When the following formula 0<Xi≦0.4 is satisfied, overlapping of the writing units of the solid image other than the both edges becomes appropriate, and density unevenness at other than the both edges can be suppressed. Therefore, it is advantageous.

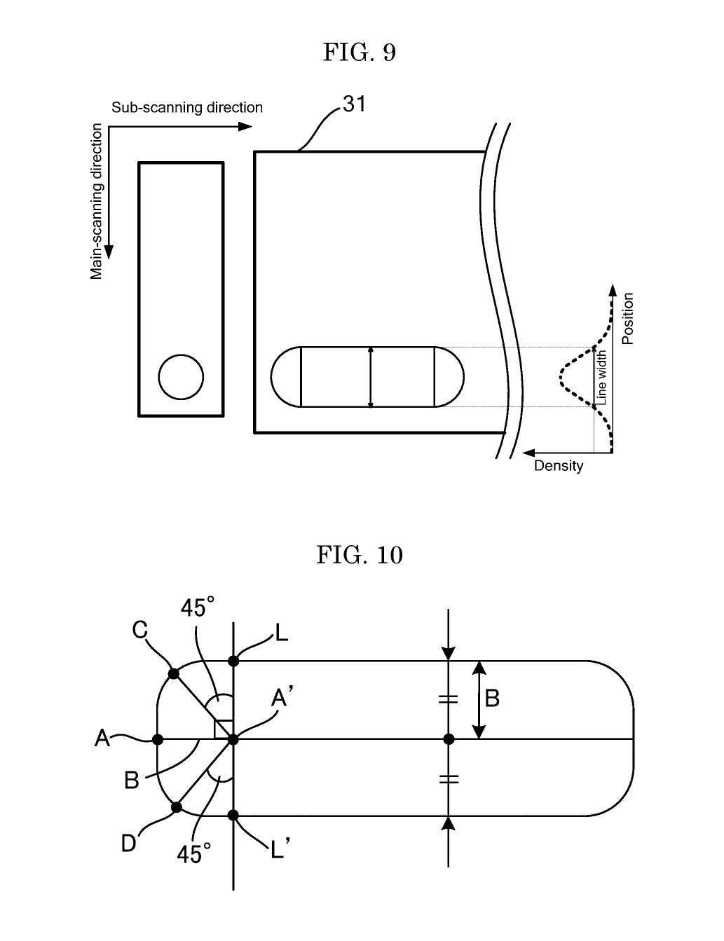

The line width W of the writing units overlapped in the main-scanning direction relative to the main-scanning direction can be determined by writing a single writing unit, as illustrated in FIG. 9, under the same conditions to the conditions for writing the solid image, except that a single laser light beam is emitted, and measuring density of the writing unit using a microdensitometer. Specifically, image density is measured by a microdensitometer (slit width: 5 μm), and an average density is calculated from the maximum value and minimum value from the measured density values. An outline of the average density is determined, and the line width W is determined by magnifying at 500 times. In the same manner, the length W can be determined.

The overlapped width L of the two adjacent writing units A and B can be determined from Mathematical Formula 1 below based on line widths Wa and Wb of the writing units A and B respectively measured by the above-described measuring method, and a pitch P of the optical fiber array.

L=WA/2+WB/2−P Mathematical Formula 1

When the writing units constituting the solid image are recorded by reducing irradiation energy of laser light stepwise towards a center direction in a certain region from the both edges to the center direction along the main-scanning direction, a high effect of reducing density unevenness can be obtained and therefore such a recording method is preferable. In this case, the writing units constituting the solid image include a combination of writing units Dn recorded with reducing irradiation energy of the laser light stepwise in a certain region from the both edges towards a center direction in the main-scanning direction (n is 1 at writing units present at the both edges relative to the main-scanning direction, followed by an integer from 2 and larger as coming close to the center direction); and writing units Dj positioned closer to a side of the center than the writing units Dn. Irradiation energy of laser light for recording the writing units Dn is larger than irradiation energy of laser light for recording the writing units Di. The following formula 1.0<Z<2.0 is preferably satisfied, where Z is a ratio (E1/Ej) of an irradiation energy value E1 of laser light for recording writing units Dn (n is 1) of both edges of a solid image relative to a main-scanning direction to an irradiation energy value Ej of laser light for recording the writing units Dj. When the following formula 1.0<Z<2.0 is satisfied, a difference between the irradiation energy E1 of the laser light for recording the writing units at both edges of the solid image and the irradiation energy Ej of the laser light for recording the writing units other than the both edges of the solid image becomes large, density unevenness of the solid image can be suppressed. Therefore, it is advantageous. When the following formula Z<2.0 is satisfied, moreover, occurrences of density unevenness due to overheating at the both edges or expansion of the image can be suppressed. Therefore, it is advantageous.

The following formula 0<Xn<0.6 is preferably satisfied, where Xn is a ratio (Ln/Ws) of an overlapped width Ln of the writing unit Dn and the writing unit Ds to Ws. Note that, n in Xn is identical to n in the writing unit Dn. When the following formula 0<Xn<0.6 is satisfied, overlapping of the writing units recorded by reducing irradiation energy of laser light stepwise towards the center direction becomes appropriate, and density unevenness between the writing units can be suppressed. Therefore, it is advantageous.

The following formula 0<Xj≦0.4 is preferably satisfied, where Xj is a ratio (Lj/Wj) of an overlapped width Lj of the main writing units Dj to each other in the main-scanning direction to a line width Wj of each main writing unit Dj in the main-scanning direction. When the following formula 0<Xj≦0.4 is satisfied, overlapped of the writing units positioned at a center side relative to the writing units recorded by reducing the irradiation energy of the laser light stepwise towards the center direction becomes appropriate, and density unevenness can be suppressed. Therefore, it is advantageous.

In the present disclosure, a method for recording an image on a recording target using the recording device including an optical fiber array, in which a plurality of optical fibers each independently driven are aligned in a main-scanning direction orthogonal to a sub-scanning direction that is a moving direction of the recording target, is not particularly limited and may be appropriately selected depending on the intended purpose. Examples of the method include: a method where a light distribution of a certain direction (e.g., a sub-scanning direction) is narrowed by modifying a shape of a lens; a method using a beam splitter; and a method using optical fibers each core shape of which is other than circle (e.g., a polygonal-core optical fiber (Top Hat Fiber (registered trademark) available from Mitsubishi Cable Industries, Ltd.).

### <Image>

The image is not particularly limited and may be appropriately selected depending on the intended purpose, as long as the image is visually recognizable information. Examples of the image include letters, symbols, lines, figures, solid images, combinations of any of the foregoing images, QR codes (registered trademark), barcodes, and two-dimensional codes.

### <Recording Target>

The recording target is not particularly limited and may be appropriately selected depending on the intended purpose, as long as the recording target is an object that absorbs light and converts the light into heat to form an image. Examples of the recording target include thermosensitive recording media, structures each including a thermosensitive recording area, and laser marking, such as engraving to metal. Among the above-listed examples, a thermosensitive recording medium and a structure including a thermosensitive recording area are preferable.

Examples of the thermosensitive recording area include an area of a surface of a structure, to which a thermosensitive recording label is bonded, and an area of a surface of a structure, which is coated with a thermosensitive recording material.

The structure including a thermosensitive recording area is not particularly limited and may be appropriately selected depending on the intended purpose, as long as the structure including a thermosensitive recording area includes the thermosensitive recording area on a surface of the structure. Examples of the structure include: various products, such as plastic bags, PET bottles, and tins; transportation containers, such as cardboard boxes and shipping containers; products in process; and industrial products.

### —Thermosensitive Recording Medium—

As the thermosensitive recording medium, a thermosensitive recording medium, to which image recording is performed once, is suitably used. Note that, a thermoreversible recording medium, to which image recording and image erasing are repetitively performed, can be also used as the thermosensitive recording medium.

The thermosensitive recording medium includes a support and a thermosensitive coloring layer on the support, and may further include other layers according to the necessity. Each of the above-mentioned layers may have a single-layer structure or a laminate structure, and may be disposed on the other surface of the support.

### —Thermosensitive Coloring Layer—

The thermosensitive coloring layer includes a material that absorbs laser light and converts the laser light into heat (photothermal conversion material) and a material that causes a change in hue or reflectance with heat, and may further include other ingredients according to the necessity.

The material that causes a change in hue or reflectance with heat is not particularly limited and may be appropriately selected depending on the intended purpose. For example, materials known in the art, such as a combination of an electron-donating dye precursor and an electron-accepting color developer used in thermosensitive paper in the art can be used. Moreover, the change of the material includes a complex reaction of heat and light, such as a discoloring reaction due to solid-phase polymerization of a diacetylene-based compound caused by heating and UV irradiation.

The electron-donating dye precursor is not particularly limited and may be appropriately selected from materials typically used for thermosensitive recording materials. Examples of the electron-donating dye precursor include leuco compounds of dyes, such as triphenyl methane-based dyes, fluoran-based dyes, phenothiazine-based dyes, auramine-based dyes, spiropyran-based dyes, and indophthalide-based dyes.

As the electron-accepting color developer, various electron-accepting compounds or oxidizers that can color the electron-donating dye precursor as contacted, can be used.

The photothermal conversion material can be roughly classified into inorganic materials and organic materials.

Examples of the inorganic materials include particles of at least one of carbon black, metal boride, and metal oxide of Ge, Bi, In, Te, Se, or Cr. Among the above-listed examples, a material that absorbs a large amount of light of a near infrared wavelength region and a small amount of light of a visible range wavelength region is preferable, and the metal boride and the metal oxide are more preferable. As the metal boride and the metal oxide, for example, at least one selected from the group consisting of hexaboride, a tungsten oxide compound, antimony tin oxide (ATO), indium tin oxide (ITO), and zinc antimonate is preferable.

Examples of the hexaboride include LaB₆, CeB₆, PrB₆, NdB₆, GdB₆, TbB₆, DyB₆, HoB₆, YB₆, SmB₆, EuB₆, ErB₆, TmB₆, YbB₆, LuB₆, SrB₆, CaB₆, and (La, Ce)B₆.

Examples of the tungsten oxide compound include particles of tungsten oxide represented by the general formula: WyOz (where W is tungsten, O is oxygen, and 2.2≦z/y≦2.999), and particles of composite tungsten oxide represented by the general formula: MxWyOz (where M is at least one element selected from the group consisting of H, He, alkali metal, alkaline earth metal, rare-earth element, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, and I, W is tungsten, O is oxygen, and 0.001≦x/y≦1, 2.2≦z/y≦3.0) as disclosed in WO2005/037932, and Japanese Unexamined Patent Application Publication No. 2005-187323. Among the above-listed examples, cesium-containing tungsten oxide is particularly preferable because absorption of light in the near infrared region is large and absorption of light in the visible region is small.

Among antimony tin oxide (ATO), indium tin oxide (ITO), and zinc antimonate, moreover, ITO is particularly preferable because absorption of light in the near infrared region is large and absorption of light in the visible region is small.

The above-listed materials may be formed into a layer by vacuum deposition or bonding a particular material with a resin.

As the organic materials, various dyes are appropriately used depending on a wavelength of light to be absorbed. In the case where a semiconductor laser is used as a light source, a near infrared absorbing dye having an absorption peak at from about 600 nm through about 1,200 nm is used. Specific examples of such a dye include cyanine dyes, quinone-based dyes, quinolone derivatives of indonaphthol, phenylene diamine-based nickel complexes, and phthalocyanine-based dyes.

The photothermal conversion material may be used alone or in combination.

The photothermal conversion material may be included in a thermosensitive coloring layer, or in a layer other than the thermosensitive coloring layer. In the case where the photothermal conversion material is included in a layer other than the thermosensitive coloring layer, a photothermal conversion layer is preferably disposed adjacent to the thermosensitive coloring layer. The photothermal conversion layer includes at least the photothermal conversion material and a binder resin.

Examples of the above-mentioned other ingredients include binder resins, thermoplastic materials, antioxidants, photostabilizers, surfactants, lubricants, and filler.

### —Support—

A shape, structure, or size of the support is not particularly limited and may be appropriately selected depending on the intended purpose. Examples of the shape include a plate shape. The structure may be a single-layer structure or a laminate structure. The size can be appropriately selected depending on a size of the thermosensitive recording medium.

### —Other Layers—

Examples of the above-mentioned other layers include a photothermal conversion layer, a protective layer, an under layer, a UV ray-absorbing layer, an oxygen-barrier layer, an intermediate layer, a backing layer, an adhesive layer, and a pressure-sensitive adhesive layer.

The thermosensitive recording medium can be processed into a desired shape depending on the intended use. Examples of the shape include a card shape, a tag shape, a label shape, a sheet shape, and a roll shape.

Examples of the thermosensitive recording medium processed into the card shape include pre-payed cards, point cards, and credit cards. The thermosensitive recording medium in the shape of the tag smaller than the card size can be used as a price tag. Moreover, the thermosensitive recording medium in the shape of the tag larger than the card size can be used for process control, shipping instructions, and thickets. Since the thermosensitive recording medium in the shape of the label can be bonded, such a thermosensitive recording medium can be processed into various sizes, and can be used for process control or goods management by bonding the thermosensitive recording medium to a dolly, container, box, or shipping container, which is repetitively used. Moreover, the thermosensitive recording medium having a sheet size lager than the card size has a large area where an image can be recorded, and therefore such a thermosensitive recording medium can be used for general documents, or instructions for process control.

The recording device of the present disclosure includes an optical fiber array, preferably includes an emitting unit, and may further include other units according to the necessity.

### <Optical Fiber Array>

In the optical fiber array, a plurality of optical fibers are aligned along a main-scanning direction orthogonal to a sub-scanning direction that is a moving direction of a recording target. The emitting unit is configured to apply emitted laser light to the recording target via the optical fiber array to recode an image formed of writing units.

An alignment of the optical fibers is not particularly limited and may be appropriately selected depending on the intended purpose. Examples of the alignment include a linear alignment, and a planar alignment. Among the above-listed examples, the linear alignment is preferable.

A minimum distance (pitch) between centers of the optical fibers is preferably 1.0 mm or less, more preferably 0.5 mm or less, and even more preferably 0.03 mm or greater but 0.15 mm or less.

When the minimum distance (pitch) between centers of the optical fibers is 1.0 mm or less, high-resolution recording is enabled, and a high-definition image compared to images generally formed in the art can be realized.

The number of the optical fibers aligned in the optical fiber array is preferably 10 or greater, more preferably 50 or greater, and even more preferably 100 or greater but 400 or less.

When the number of the optical fibers aligned is 10 or greater, high-speed recording is enabled, and a high-definition image compared to images generally formed in the art can be realized.

An optical system, such as an optical system composed of lenses, can be disposed to follow the optical fiber array in order to control a spot diameter of the laser light.

An optical fiber array head, in which a plurality of the optical fiber arrays are disposed in lines along the main-scanning direction, may be formed depending on a size of the recording target in the main-scanning direction.

### —Optical Fiber—

The optical fiber is an optical waveguide of laser light emitted from the emitting unit.

Examples of the optical fiber include optical fibers.

A shape, size (diameter), material, or structure of the optical fiber is not particularly limited and may be appropriately selected depending on the intended purpose.

A size (diameter) of the optical fiber is preferably 15 μm or greater but 1,000 μm or smaller, and more preferably 20 μm or greater but 800 μm or smaller. The optical fiber having a diameter of 15 μm or greater but 1,000 μm or smaller is advantageous in view of high image definition.

A material of the optical fiber is not particularly limited and may be appropriately selected depending on the intended purpose. Examples of the material include quartz, glass, and resins.

A transmission wavelength range of the material of the optical fiber is not particularly limited and may be appropriately selected depending on the intended purpose. The transmission wavelength range is preferably 700 nm or longer but 2,000 nm or shorter, and more preferably 780 nm or longer but 1,600 nm or shorter.

The structure of the optical fiber is preferably a structure including a core that is a center through which laser light is transmitted, and a cladding layer disposed at the periphery of the core.

A diameter of the core is not particularly limited and may be appropriately selected depending on the intended purpose. The diameter is preferably 10 μm or greater but 500 μm or less, and more preferably 15 μm or greater but 400 μm or less.

A material of the core is not particularly limited and may be appropriately selected depending on the intended purpose. Examples of the material include germanium-doped or phosphorus-doped glass.

An average thickness of the cladding layer is not particularly limited and may be appropriately selected depending on the intended purpose. The average thickness is preferably 10 μm or greater but 250 μm or less, and more preferably 15 μm or greater but 200 μm or less.

A material of the cladding layer is not particularly limited and may be appropriately selected depending on the intended purpose. Examples of the material include boron-doped or fluorine-doped glass.

### <Emitting Unit>

The emitting unit is a unit configured to apply emitted laser light to the recording target via the optical fiber array.

The emitting unit can control a length of each writing unit along the sub-scanning direction with a cycle and duty ratio of an input pulse signal based on the pulse signal and a spot diameter of the laser light on the recording target, and can record with edges of the writing units adjacent to each other in the sub-scanning direction overlapping in the sub-scanning direction.

The emitting unit is not particularly limited and may be appropriately selected depending on the intended purpose. Examples of the emitting unit include a semiconductor laser, and a solid optical fiber laser. Among the above-listed examples, a semiconductor laser is preferable because the semiconductor laser has a wide wavelength selectivity, a size of a device of the semiconductor laser is small, and the semiconductor laser is low cost.

A wavelength of the laser light is not particularly limited and may be appropriately selected depending on the intended purpose. The wavelength is preferably 700 nm or longer but 2,000 nm or shorter, and more preferably 780 nm or longer but 1,600 nm or shorter.

An output of the laser light is not particularly limited and may be appropriately selected depending on the intended purpose. The output is preferably 1 W or greater, but more preferably 3 W or greater. When the output of the laser light is 1 W or greater, it is advantageous in view of high density of an image.

A shape of a spot writing unit of the laser light is not particularly limited and may be appropriately selected depending on the intended purpose. Examples of the shape include a circle, an oval, and various polygons, such as a triangle, a square, a pentagon, and a hexagon. Among the above-listed examples, a circle and an oval are preferable.

A spot writing unit of the laser light being an oval means as follows. When a straight line is drawn on a recording target with a single beam of identical energy as illustrated in FIG. 10, ½ a line width is determined as B, a center of a left edge of the line is determined as A, points vertically crossing with the drawn straight line with the points moved from the starting point A of the line towards the center direction of the line width by the distance B are determined as L and L′, and a cross point between a vertical line from the starting point A of the line and the line LL′ is determined as A′. When a distance A′C where C is a boundary of the drawn line that is in the 45° top-left direction from A is longer than B, the spot writing unit is an oval. Alternatively, when a distance A′D where D is a boundary of the drawn line that is in the 45° left-down direction from A′ is longer than B, the spot writing unit is an oval. The distance A′C and the distance A′D are almost identical, and the phrase “almost identical” means that a difference is in the range of ±10% or less.

A ling width can be determined from a result of a density distribution measurement of a writing unit. Typically, around a center of the writing unit has high recording density, and a peripheral area of the writing unit has low recording density. The line width of the writing unit along the main-scanning direction can be determined by measuring a density profile of the writing unit along the main-scanning direction, calculating an average density from the maximum value and minimum value from the measured density values, determining an outline of the average density, and magnifying at 500 times.

In the present specification, the maximum value (maximum recording density) means optical density of an area where an optical change caused by laser recording is the largest. The maximum recording density includes a case where the optical density is increased by laser recording compared to an unrecorded area, and also a case where the optical density is decreased by laser recording compared to an unrecorded area.

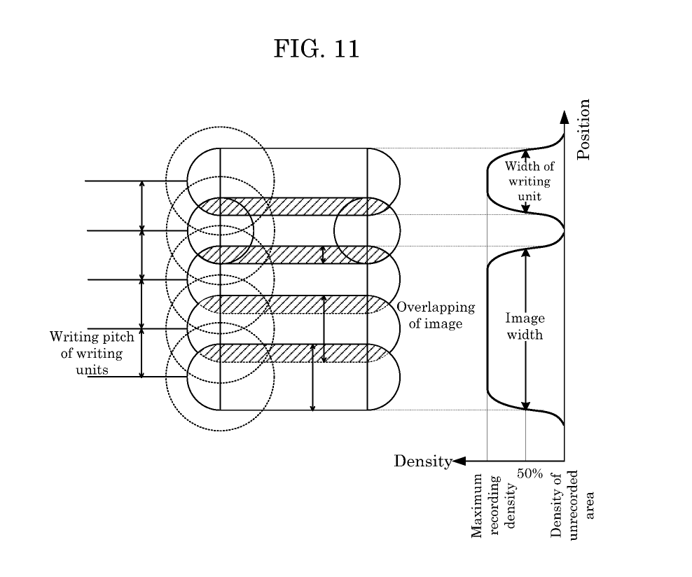

As a device for measuring a density profile of a writing unit along the main-scanning unit, a microdensitometer (PDM-7, available from available from KONICA MINOLTA, INC.) can be used. Note that, the definitions of a line width of a writing unit is presented in FIG. 11.

A size (spot diameter) of the laser spot writing unit of the laser light is not particularly limited and may be appropriately selected depending on the intended purpose. The size is preferably 30 μm or greater but 5,000 μm or less.

The spot diameter is not particularly limited and may be appropriately selected depending on the intended purpose. For example, the spot diameter can be measured by means of a beam profiler.

Control of the laser is not particularly limited and may be appropriately selected depending on the intended purpose. The control may be pulse control or continuous control.

### <Other Units>

Other units are not particularly limited and may be appropriately selected depending on the intended purpose. Examples of the above-mentioned other units include a driving unit, a controlling unit, a main-controlling unit, a cooling unit, a power-supplying unit, and a conveying unit.

### —Driving Unit—

The driving unit is configured to output the pulse signal, which is generated based on a driving signal input from the controlling unit, to the emitting unit to drive the emitting unit.

The driving units are respectively disposed to a plurality of the emitting units, and are configured to independently drive the emitting units.

### —Controlling Unit—

The controlling unit is configured to output a driving signal, which is generated based on image information transmitted from the main-controlling unit, to the driving unit to control the driving unit.

### —Main-Controlling Unit—

The main-controlling unit includes a central processing unit (CPU) configured to control each operation of the recording device, and is configured to prosecute various processes based on a control program for controlling operation of the entire recording device of the present disclosure.

Examples of the main-controlling unit include a computer.

The main-controlling unit is coupled with the controlling unit in a manner that the main-controlling unit and the controlling unit can communicate, and the main-controlling unit transmits image information to the controlling unit.

### —Cooling Unit—

The cooling unit is disposed near the driving unit and the controlling unit to cool the driving unit and the controlling unit. When a duty ratio of a pulse signal is high, time of laser oscillation is long, and therefore it becomes difficult to cool the driving unit and the controlling unit with the cooling unit. As a result, irradiation energy of laser light varies, and an image may not be able to record stably.

### —Power-Supplying Unit—

The power-supplying unit is configured to supply power to the controlling unit.

### —Conveying Unit—

The conveying unit is not particularly limited and may be appropriately selected depending on the intended purpose, as long as the conveying unit is capable of conveying the recording target in a sub-scanning direction. Examples of the conveying unit include a linear slider.

Conveying speed of the recording target by the conveying unit is not particularly limited and may be appropriately selected depending on the intended purpose. The conveying speed is preferably 10 mm/s or greater but 10,000 mm/s or less, and more preferably 100 mm/s or greater but 8,000 mm/s or less.

One example of the recording device of the present disclosure for use in the recording method of the present disclosure is described with reference to drawings.

Note that, identical reference numerals are provided to identical structural members in drawings, and duplicated descriptions may be omitted. Moreover, the number, positions, and shapes of the structural members below are not limited to the embodiment of the present disclosure, and the number, positions, and shapes suitable for carrying out the present disclosure can be selected.

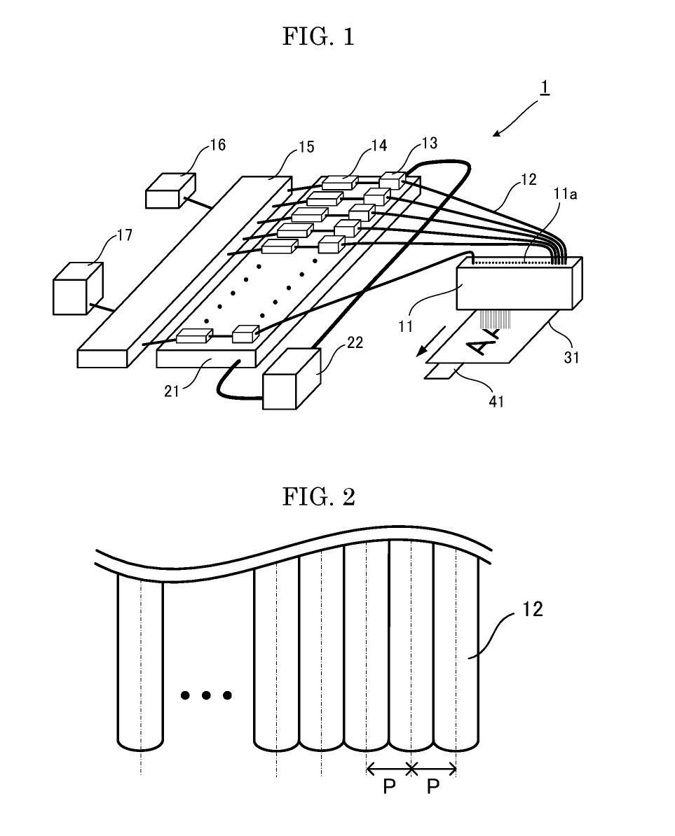

FIG. 1 is a schematic view illustrating one example of the recording device of the present disclosure including an optical fiber array.

As illustrated in FIG. 1, the recording device 1 records an image formed of writing units using an optical fiber array 11, in which a plurality of optical fibers 12 in a main-scanning direction orthogonal to a subs-scanning direction that is a moving direction of a recording target 31 and is presented with an arrow in FIG. 1, and a plurality of emitting units 13 respectively coupled to the optical fibers 12 of the optical fiber array 11 in a manner that the emitting units can emit laser light to the optical fibers 12, by applying laser light from the optical fiber array 11 to a recording target 31 with conveying the recording target 31 in the sub-scanning direction.

The optical fiber array 11 is such that a plurality of the array head 11a are linearly aligned along the main-scanning direction, and includes an optical system, which is capable of controlling a spot diameter of laser light and is not illustrated in FIG. 1, on a light path of laser light emitted from the array head 11a.

The recording device 1 controls a length of the writing unit in the sub-scanning direction with a spot diameter of laser light to the recording target 31, and a cycle and duty ratio of a pulse signal input to the emitting unit 13 by the driving unit 14, to record with overlapping, in the sub-scanning direction, edges of the writing units adjacent to each other in the sub-scanning direction.

The emitting unit 13 is a semiconductor laser. A wavelength of laser light emitted from the emitting unit is 915 nm, and output of laser light of the emitting unit is 30 W.

The driving unit 14 is configured to output a pulse signal, which is generated based on a driving signal input from the controlling unit 15, to the emitting unit 13 to drive the emitting unit 13.

The driving units 14 are respectively disposed to a plurality of the emitting units 13, and are configured to independently drive the emitting units 13.

The controlling unit 15 is configured to output a driving signal, which is generated based on image information transmitted from the main-controlling unit 16, to the driving unit 14 to control the driving unit 14.

The main-controlling unit 16 includes a central processing unit (CPU) configured to control each operation of the recording device 1, and is configured to prosecute various processes based on a control program for controlling operation of the entire recording device 1.

The main-controlling unit 16 is coupled to the controlling unit 15 in a manner that the main-controlling unit and the controlling unit can be communicate, and is configured to transmit image information to the controlling unit 15.

The power-supplying unit 17 is configured to supply power to the controlling unit 15.

The cooling unit 21 is disposed below the driving unit and the controlling unit, and is configured to cool the driving unit and the controlling unit using a liquid of a constant temperature circulated by a chiller 22.

Typically, only cooling is performed in a chiller system without performing heating. Therefore, a temperature of a light source never be higher than a set temperature of the chiller, but the temperature of the cooling unit and the temperature of the laser light source to be in contact with may vary depending on an environmental temperature. In the case where a semiconductor laser is used as a laser light source, meanwhile, output of laser varies depending on a temperature of the laser light source (the output of laser is high when the temperature of the laser light source is low). In order to control output of laser, a regular image formation is preferably formed by measuring a temperature of a laser light source or a temperature of a cooling unit, an input signal to a driving circuit configured to control output of the laser is controlled to make the laser output constant depending on the result of the measurement.

The conveying unit 41 is configured to convey the recording target 31 in the sub-scanning direction.

FIG. 2 is an enlarged partial view of the array head 11a of FIG. 1. The array head 11a includes a plurality of the optical fibers 12 which are linearly aligned along the main-scanning direction, and the pitch P of the optical fibers 12.

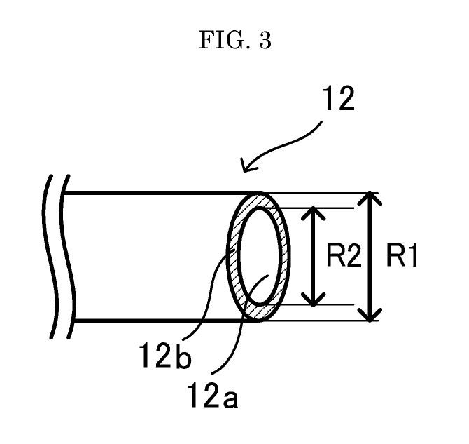

FIG. 3 is an enlarged partial view of the optical fiber of FIG. 2.

As illustrated in FIG. 3, the optical fiber 12 includes a core 12a that is a center through which laser light is transmitted, and a cladding layer 12b disposed at the periphery of the core 12a, and has a structure where a refractive index of the core 12a is higher than a refractive index of the cladding layer 12b so that laser light is transmitted only through the core 12a with total reflection or refraction.

A diameter R1 of the optical fiber 12 is 125 μm, and a diameter R2 of the core 12a is 105 μm.

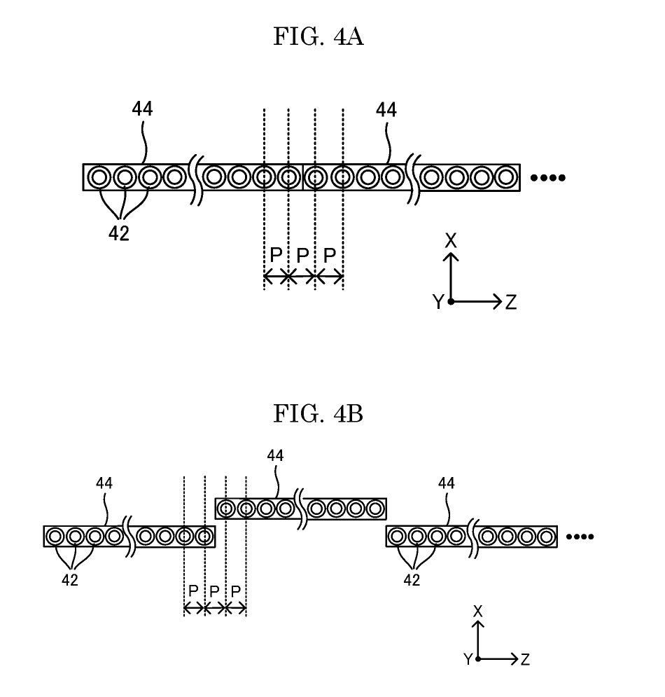

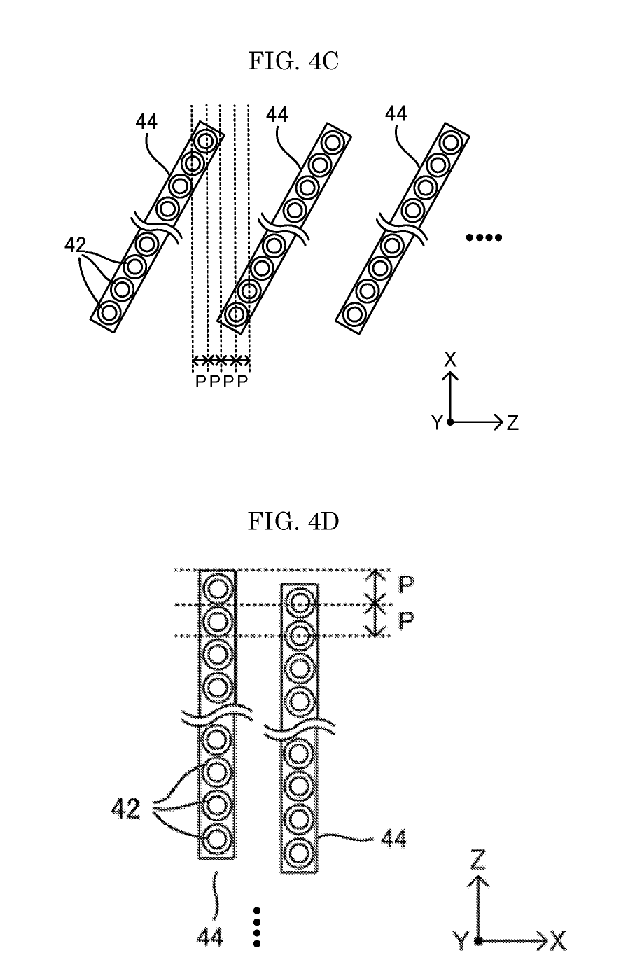

FIGS. 4A to 4D are view illustrating examples of an arrangement of array heads. In FIGS. 4A to 4D, X represents a sub-scanning direction and Z represents a main-scanning direction.

The optical fiber array 11 may be composed of one array head. In case of a long optical fiber array head, however, the array head itself is long and tends to be deformed. Therefore, it is difficult to maintain a straight line of arraignments of beams, or uniformity of pitches of the beams. Accordingly, a plurality of the array heads 44 may be arranged in arrays along a main-scanning direction (Z-axis direction), as illustrated in FIG. 4A, or may be arranged in a grid, as illustrated in FIG. 4B. In the example of the recording device including the optical fiber array according to the present disclosure illustrated in FIG. 1, one array head aligned along the main-scanning direction is mounted.

The grid arrangement of the array heads 44 as illustrated in FIG. 4B is more preferable than the linear arrangement in the main-scanning direction (Z-axis direction) as illustrated in FIG. 4A in view of easiness of assembly.

Moreover, the array heads 44 may be arranged with inclination along a sub-scanning direction. The array heads 44 may be arranged with inclination along the sub-scanning direction (X-axis direction), as illustrated in FIG. 4C. When the array heads 44 are arranged with inclination along the sub-scanning direction (X-axis direction) as illustrated in FIG. 4C, a pitch P of the optical fibers 42 in the main-scanning direction (Z-axis direction) can be narrowed compared to the arrangements illustrated in FIGS. 4A and 4B, to thereby achieve high resolution.

Moreover, the array heads 44 may be arranged with slightly sifting in the main-scanning direction (Z-axis direction), as illustrated in FIG. 4D. High resolution can be realized by arranging the array heads as illustrated in FIG. 4D.

### EXAMPLES

The present disclosure will be described in more detail by way of the following Examples. However, the present disclosure should not be construed as being limited to these Examples.

### Production Example 1

### —Production of Thermosensitive Recording Medium—

### (1) Preparation of Dye Dispersion Liquid (A Liquid)

The following composition was dispersed by a sand mill to prepare a dye dispersion liquid (A Liquid).

| | |
|---|---|
| 2-anilino-3-methyl-6-dibutylaminofluoran | 20 parts by mass |
| 10% by mass polyvinyl alcohol aqueous solution | 20 parts by mass |
| Water | 60 parts by mass |

### (2) Preparation of B Liquid

The following composition was dispersed by means of a ball mill to prepare B Liquid.

| | |
|---|---|
| 4-hydroxy-4′-isopropoxydiphenylsulfone | 20 parts by mass |
| 10% by mass polyvinyl alcohol aqueous solution | 20 parts by mass |
| Water | 60 parts by mass |

### (3) Preparation of C Liquid

The following composition was dispersed by means of a ball mill to prepare C Liquid.

| | |
|---|---|
| Photothermal conversion material (indium tin | 20 parts by mass |
| oxide (ITO)) | |
| Polyvinyl alcohol aqueous solution (solid | 20 parts by mass |
| content: 10% by mass) | |
| Water | 60 parts by mass |

### (4) Preparation of Thermosensitive Coloring Layer Coating Liquid

The following composition was mixed to prepare a thermosensitive coloring layer coating liquid.

| | | |
|---|---|---|
| A Liquid above | 20 | parts by mass |
| B Liquid above | 40 | parts by mass |
| C Liquid above | 2 | parts by mass |
| Polyvinyl alcohol aqueous solution (solid | 30 | parts by mass |
| content: 10% by mass) | | |
| Dioctyl sulfosuccinate aqueous solution | 1 | part by mass |
| (solid content: 5% by mass) | | |

Next, wood-free paper having a basis weight of 60 g/m² was used as a support. Onto the wood-free paper, the thermosensitive coloring layer coating liquid was applied in a manner that a dry deposition amount of the dye contained in the thermosensitive coloring layer coating liquid was to be 0.5 g/m², followed by drying to thereby form a thermosensitive coloring layer. As described above, a thermosensitive recording medium as a recording target was produced.

The recording device illustrated in FIGS. 1 to 3 had 32 fiber-coupling LDs each having a maximum output of 30 W as the emitting unit. As the optical fiber array, 32 optical fibers (diameter of the optical fiber: 125 μm, diameter of the core: 105 μm) were aligned in the main-scanning direction, and a pitch X between adjacent optical fibers was 127 μm.

### Writing Examples 1 to 17

By means of a recording device illustrated in FIGS. 1 to 3, an image, which had a length of 100 mm in a sub-scanning direction and was formed of 32 writing units, was formed on a thermosensitive recording medium serving as a recording target, with setting a relative moving speed with the produced recording target to 2 m/sec/, and varying incident energy. The energy EO at which the line width reached 127 μm was determined and was set as standard energy. Next, an image was recorded by means of one fiber coupling LD among the 32 fiber coupling LDs at the energy denoted in Table 1 with the energy EO as a standard to thereby determine a line width at each energy. The results are presented in Table 1.

TABLE 1

| | Writing Example | | | | | | | | | | | | | | | | |
|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 | 17 |
| Irradiation | 61 | 71 | 82 | 92 | 102 | 107 | 112 | 122 | 133 | 153 | 163 | 173 | 194 | 204 | 214 | 224 | 235 |
| energy (%) | | | | | | | | | | | | | | | | | |
| Line width | 70 | 83 | 102 | 110 | 132 | 137 | 143 | 158 | 171 | 196 | 210 | 221 | 247 | 260 | 275 | 283 | 299 |
| (μm) | | | | | | | | | | | | | | | | | |

### Examples 1 to 11 and Comparative Examples 1 to 13

By means of a recording device illustrated in FIGS. 1 to 3, an image, which had a length of 100 mm in a sub-scanning direction and was formed of 32 writing units, was formed on a thermosensitive recording medium serving as a recording target under the conditions denoted in Tables 2 and 3.

### <Evaluation of Density Unevenness>

Density values in the both edge areas, and center area of the obtained image relative to the main-scanning direction were measured by means of a microdensitometer (PDM-7, available from available from KONICA MINOLTA, INC.) and density unevenness was evaluated based on the following criteria. The results are presented in Tables 2-1, 2-2, and 3.

### [Evaluation Criteria]

A: The density difference between the highest density area and the palest area was less than 0.1, and density unevenness was not visually observed at all.
B: The density difference between the highest density area and the palest area was 0.1 or greater but less than 0.2, and density unevenness was slightly visually observed, but the resulting image was sufficiently acceptable level.
C: The density difference between the highest density area and the palest area was 0.2 or greater but less than 0.4, and density unevenness was easily visually observed, which was insufficient and unacceptable level.
D: The density difference between the highest density area and the palest area was 0.4 or greater, and density unevenness was significant, which was a practically unusable level.

TABLE 2-1

| | | Example | | | | | | | |
|---|---|---|---|---|---|---|---|---|---|
| | | 1 | 2 | 3 | 4 | 5 | 6 | 7 | 8 |
| Irradiation energy | Eo | 112.2 | 122.4 | 224.4 | 153.0 | 193.8 | 224.4 | 173.4 | 234.6 |
| for writing units Do | | | | | | | | | |
| of both edges | | | | | | | | | |
| Irradiation energy | Ei | 102.0 | 112.2 | 112.2 | 132.6 | 132.6 | 132.6 | 163.2 | 163.2 |
| of writing units Di | | | | | | | | | |
| other than both edges | | | | | | | | | |
| Y | (Eo/Ei) | 1.10 | 1.09 | 2.00 | 1.15 | 1.46 | 1.69 | 1.06 | 1.44 |
| Wo | (μm) | 143 | 158 | 283 | 196 | 247 | 283 | 221 | 299 |
| Wi | (μm) | 132 | 143 | 143 | 171 | 171 | 171 | 210 | 210 |
| Lo | (μm) | 7.5 | 20.5 | 83.0 | 53.5 | 79.0 | 97.0 | 85.5 | 124.5 |
| Xo | (Lo/Wi) | 0.0568 | 0.14 | 0.58 | 0.31 | 0.46 | 0.57 | 0.41 | 0.59 |
| Wi | (μm) | 132 | 143 | 143 | 171 | 171 | 171 | 210 | 210 |
| Li | (μm) | 2 | 13 | 13 | 41 | 41 | 41 | 80 | 80 |
| Xi | (Li/Wi) | 0.0152 | 0.0909 | 0.09 | 0.24 | 0.24 | 0.24 | 0.38 | 0.38 |
| Density unevenness | | B | B | B | A | A | B | B | B |
| at both edges | | | | | | | | | |
| Density unevenness | | B | B | B | A | A | A | B | B |
| at center | | | | | | | | | |

TABLE 2-2

| | | Comparative Example | | | | | | | | |
|---|---|---|---|---|---|---|---|---|---|---|
| | | 1 | 2 | 3 | 4 | 5 | 6 | 7 | 8 | 9 |
| Irradiation energy | Eo | 102.0 | 102.0 | 193.8 | 255.0 | 102.0 | 255.0 | 102.0 | 193.8 | 255.0 |
| for writing units Do | | | | | | | | | | |
| of both edges | | | | | | | | | | |
| Irradiation energy | Ei | 91.8 | 112.2 | 91.8 | 91.8 | 132.6 | 132.6 | 193.8 | 193.8 | 193.8 |
| of writing units Di | | | | | | | | | | |
| other than both edges | | | | | | | | | | |
| Y | (Eo/Ei) | 1.11 | 0.91 | 2.11 | 2.78 | 0.77 | 1.92 | 0.53 | 1.00 | 1.32 |
| Wo | (μm) | 132 | 132 | 247 | 320 | 132 | 320 | 132 | 247 | 320 |
| Wi | (μm) | 110 | 143 | 110 | 110 | 171 | 171 | 247 | 247 | 247 |
| Lo | (μm) | −9.0 | 7.5 | 48.5 | 85.0 | 21.5 | 115.5 | 59.5 | 117.0 | 153.5 |
| Xo | (Lo/Wi) | −0.08 | 0.05 | 0.44 | 0.77 | 0.13 | 0.68 | 0.24 | 0.47 | 0.62 |
| Wi | (μm) | 110 | 143 | 110 | 110 | 171 | 171 | 247 | 247 | 247 |
| Li | (μm) | −20 | 13 | −20 | −20 | 41 | 41 | 117 | 117 | 117 |
| Xi | (Li/Wi) | −0.18 | 0.09 | −0.18 | −0.18 | 0.24 | 0.24 | 0.47 | 0.47 | 0.47 |
| Density unevenness | | D | D | C | C | D | D | D | C | D |
| at both edges | | | | | | | | | | |
| Density unevenness | | D | B | D | D | B | B | C | C | C |
| at center | | | | | | | | | | |

TABLE 3

| | | Ex. | | | Comp. Ex. | | | |
|---|---|---|---|---|---|---|---|---|
| | | 9 | 10 | 11 | 10 | 11 | 12 | 13 |
| Irradiation energy | E1 | 112 | 122 | 235 | 102 | 102 | 102 | 255 |
| of writing units Dn | | | | | | | | |
| (n = 1) at both edges | | | | | | | | |
| Irradiation energy | E2 | 107 | 112 | 194 | 107 | 107 | 107 | 235 |
| of writing units Dn | | | | | | | | |
| (n = 2) towards the | | | | | | | | |
| center from both edges | | | | | | | | |
| by 1 writing unit | | | | | | | | |
| Irradiation energy | E3 | NA | 105 | 160 | NA | 110 | 110 | 210 |
| of writing units Dn | | | | | | | | |
| (n = 2) towards the | | | | | | | | |
| center from both edges | | | | | | | | |
| by 2 writing units | | | | | | | | |
| Irradiation energy | Ej | 100 | 100 | 130 | 110 | 130 | 130 | 190 |
| of writing units Dj | | | | | | | | |
| at center side from | | | | | | | | |
| the writing units Dn | | | | | | | | |
| Z | (Eo/Ei) | 1.10 | 1.20 | 1.77 | 0.91 | 0.77 | 0.77 | 1.32 |
| Overlapping ratio of | X1 | 0.07 | 0.14 | 0.58 | 0.03 | 0.03 | 0.03 | 0.60 |
| writing unit adjacent | | | | | | | | |
| to Dn (n = 1) at | | | | | | | | |
| the inner side | | | | | | | | |
| Overlapping ratio of | X2 | 0.03 | 0.07 | 0.47 | 0.07 | 0.14 | 0.14 | 0.58 |
| writing unit adjacent | | | | | | | | |
| to Dn (n = 2) at | | | | | | | | |
| the inner side | | | | | | | | |
| Overlapping ratio of | X3 | NA | 0.03 | 0.35 | NA | NA | NA | NA |
| writing units adjacent | | | | | | | | |
| to Dn (n = 3) at | | | | | | | | |
| the inner side | | | | | | | | |
| Overlapping ratio of | Xi | 0.02 | 0.02 | 0.24 | 0.09 | 0.24 | 0.24 | 0.47 |
| writing units Dj | | | | | | | | |
| other than both edges | | | | | | | | |
| stepwise reduction area | | | | | | | | |
| Density unevenness | | A | A | A | D | D | D | C |
| at both edges | | | | | | | | |
| Density unevenness | | B | B | A | B | A | A | C |
| at center | | | | | | | | |

For example, embodiments of the present disclosure are as follows.

<1> A recording method including:

emitting laser light from an optical fiber array to record an image formed of writing units with moving a recording target and the optical fiber array relatively using a recording device including a plurality of laser light-emitting elements, and an emitting unit including the optical fiber array, in which a plurality of optical fibers configured to guide laser light emitted from the laser light-emitting elements are aligned, wherein, in a case where the laser light is applied from the optical fibers adjacent to each other in the main-scanning direction to the recording target to record a solid image formed of the writing units at least partially overlapped to each other in the main-scanning direction, recording is performed by reducing irradiation energy of the laser light for recording the writing units other than both edges of the solid image relative to the main-scanning direction, compared to irradiation energy of the laser light for recording the writing units present at the both edges of the solid image.

<2> The recording method according to <1>,
wherein the writing units constituting the solid image satisfy all of a relationship represented by Mathematical Formula 1 below, a relationship represented by Mathematical Formula 2 below, and a relationship represented by Mathematical Formula 3 below,

1.0<Y<2.0 Mathematical Formula 1

0<Xo<0.6 Mathematical Formula 2

0<Xi≦0.4 Mathematical Formula 3

where, in Mathematical Formula 1, Y is a ratio (Eo/Ei) of irradiation energy Eo of the laser light for recording writing units Do present at the both edges of the solid image relative to the main-scanning direction to irradiation energy Ei of the laser light for recording writing units Di other than the both edges; in Mathematical Formula 2, Xo is a ratio (Lo/Wi) of an overlapped width Lo of the writing units Do at the both edges constituting the solid image and the writing units Di adjacent to the both edges but other than the both edges along the main-scanning direction to a line width Wi of the writing units, which constitute the solid image and adjacent to the both edges, along the main-scanning direction; and in Mathematical Formula 3, Xi is a ratio (Li/Wi) of an overlapped width Li of the adjacent writing units Di, which constitute the solid image and are other than the both edges, along the main-scanning direction, to the line width Wi of the adjacent writing units Di, which constitute the solid image and are other than the both edges, along the main-scanning direction.
<3> The recording method according to <1>,
wherein the writing units constituting the solid image are a combination of writing units Dn recorded with reducing irradiation energy of the laser light stepwise in a certain region from the both edges towards a center direction in the main-scanning direction, where n is 1 at writing units present at the both edges relative to the main-scanning direction, followed by an integer from 2 and larger as coming close to the center direction; and writing units Dj positioned closer to a side of the center than the writing units Dn, and irradiation energy of laser light for recording the writing units Dn is larger than irradiation energy of laser light for recording the writing units Di.
<4> The recording method according to <3>,
wherein the writing units constituting the solid image satisfy all of a relationship represented by Mathematical Formula 4 below, a relationship represented by Mathematical Formula 5 below, and a relationship represented by Mathematical Formula 6 below,

1.0<Z<2.0 Mathematical Formula 4

0<Xn<0.6 Mathematical Formula 5

0<Xj≦0.4 Mathematical Formula 6

where, in Mathematical Formula 4, Z is a ratio (E1/Ej) of an irradiation energy value E1 of the laser light for recording writing units Dn (n is 1) present at the both edges of the solid image relative to the main-scanning direction to an irradiation energy value Ej of laser light for recording the writing units Dj; in Mathematical Formula 5, Xn is a ratio (Ln/Ws) of an overlapped width Ln of the writing unit Dn and the writing unit Ds to a line width Ws of a writing unit Ds adjacent to the writing unit Dn at a side of a center relative to the main-scanning direction, where n in Xn is identical to n in the writing unit Dn; and in Mathematical Formula 6, Xj is a ratio (Lj/Wj) of an overlapped width Lj of the main writing units Dj along the main-scanning direction to a line width Wj of the main writing unit Dj along the main-scanning direction.
<5> The recording method according to any one of <1> to <4>,
wherein a minimum distance between centers of the optical fibers is 1.0 mm or less.
<6> The recording method according to any one of <1> to <5>,
wherein the number of the optical fibers aligned in the optical fiber array is 10 or greater.
<7> The recording method according to any one of <1> to <6>,
wherein the recording target is a thermosensitive recording medium, a structure including a thermosensitive recording area, or both.
<8> The recording method according to any one of <1> to <7>,
wherein the emitting laser light to the recording target to record an image is performed, while the recording target is conveyed by a recording target-conveying unit that is configured to convey the recording target.
<9> A recording device including:
a plurality of laser light-emitting elements; and
an emitting unit including an optical fiber array, in which a plurality of optical fibers configured to guide laser light emitted from the laser light-emitting elements are aligned,
wherein the recording device is configured to apply laser light emitted from the optical fiber array with moving a recording target and the optical fiber array relatively, to record an image formed of writing units, wherein, in a case where the laser light is applied from the optical fibers adjacent to each other in the main-scanning direction to the recording target to record a solid image formed of the writing units at least partially overlapped to each other in the main-scanning direction, recording is performed by reducing irradiation energy of the laser light for recording the writing units other than both edges of the solid image relative to the main-scanning direction, compared to irradiation energy of the laser light for recording the writing units present at the both edges of the solid image.
<10> The recording device according to <9>,
wherein the writing units constituting the solid image satisfy all of a relationship represented by Mathematical Formula 1 below, a relationship represented by Mathematical Formula 2 below, and a relationship represented by Mathematical Formula 3 below,

1.0<Y<2.0 Mathematical Formula 1

0<Xo<0.6 Mathematical Formula 2

0<Xi≦0.4 Mathematical Formula 3

where, in Mathematical Formula 1, Y is a ratio (Eo/Ei) of irradiation energy Eo of the laser light for recording writing units Do present at the both edges of the solid image relative to the main-scanning direction to irradiation energy Ei of the laser light for recording writing units Di other than the both edges; in Mathematical Formula 2, Xo is a ratio (Lo/Wi) of an overlapped width Lo of the writing units Do at the both edges constituting the solid image and the writing units Di adjacent to the both edges but other than the both edges along the main-scanning direction to a line width Wi of the writing units, which constitute the solid image and adjacent to the both edges, along the main-scanning direction; and in Mathematical Formula 3, Xi is a ratio (Li/Wi) of an overlapped width Li of the adjacent writing units Di, which constitute the solid image and are other than the both edges, along the main-scanning direction, to the line width Wi of the adjacent writing units Di, which constitute the solid image and are other than the both edges, along the main-scanning direction.
<11> The recording device according to <9> or <10>,
wherein the writing units constituting the solid image are recorded by reducing irradiation energy of the laser light stepwise in a certain region from the writing units present at both edges towards the writing units present at a center direction along the main-scanning direction, and in the region, the irradiation energy of the laser light for recording the writing units at the center direction is lower than the irradiation energy for laser light for recording the writing units at the both ends by 1% or greater but 30% or less.
<12> The recording device according to <11>,
wherein the writing units constituting the solid image satisfy all of a relationship represented by Mathematical Formula 4 below, a relationship represented by Mathematical Formula 5 below, and a relationship represented by Mathematical Formula 6 below,

1.0<Z<2.0 Mathematical Formula 4

0<Xn<0.6 Mathematical Formula 5

0<Xj≦0.4 Mathematical Formula 6

where, in Mathematical Formula 4, Z is a ratio (E1/Ej) of an irradiation energy value E1 of the laser light for recording writing units Dn (n is 1) present at the both edges of the solid image relative to the main-scanning direction to an irradiation energy value Ej of laser light for recording the writing units Dj; in Mathematical Formula 5, Xn is a ratio (Ln/Ws) of an overlapped width Ln of the writing unit Dn and the writing unit Ds to a line width Ws of a writing unit Ds adjacent to the writing unit Dn at a side of a center relative to the main-scanning direction, where n in Xn is identical to n in the writing unit Dn; and in Mathematical Formula 6, Xj is a ratio (Lj/Wj) of an overlapped width Lj of the main writing units Dj along the main-scanning direction to a line width Wj of the main writing unit Dj along the main-scanning direction.
<13> The recording device according to any one of <9> to <12>,
wherein a minimum distance between centers of the optical fibers is 1.0 mm or less.
<14> The recording device according to any one of <9> to <13>,
wherein the number of the optical fibers aligned in the optical fiber array is 10 or greater.
<15> The recording device according to any one of <9> to <14>,
wherein irradiation power of the laser light is controlled depending on a temperature of the laser light-emitting element.
<16> The recording device according to any one of <9> to <15>,
wherein the recording target is a thermosensitive recording medium, a structure including a thermosensitive recording area, or both.
<17> The recording device according to any one of <9> to <16>, further including a recording target-conveying unit that is configured to convey the recording target,
wherein laser light is applied to the recording target to record an image while conveying the recording target by the recording target-conveying unit.

The recording method according to any one of <1> to <8> and the recording method according to any one of <9> to <17> can solve the above-described various problems in the art and can achieve the object of the present disclosure.

What is claimed is:

1. A recording method comprising:
emitting laser light from an optical fiber array to record an image formed of writing units with moving a recording target and the optical fiber array relatively using a recording device including a plurality of laser light-emitting elements, and an emitting unit including the optical fiber array, in which a plurality of optical fibers configured to guide laser light emitted from the laser light-emitting elements are aligned, wherein, in a case where the laser light is applied from the optical fibers adjacent to each other in a main-scanning direction to the recording target to record a solid image formed of the writing units at least partially overlapped to each other in the main-scanning direction, recording is performed by reducing irradiation energy of the laser light for recording the writing units other than both edges of the solid image relative to the main-scanning direction, compared to irradiation energy of the laser light for recording the writing units present at the both edges of the solid image.

2. The recording method according to claim 1,
wherein the writing units constituting the solid image satisfy all of a relationship represented by Mathematical Formula 1 below, a relationship represented by Mathematical Formula 2 below, and a relationship represented by Mathematical Formula 3 below,
1.0<Y<2.0 Mathematical Formula 1
0<Xo<0.6 Mathematical Formula 2
0<Xi≦0.4 Mathematical Formula 3
where, in Mathematical Formula 1, Y is a ratio (Eo/Ei) of irradiation energy Eo of the laser light for recording writing units Do present at the both edges of the solid image relative to the main-scanning direction to irradiation energy Ei of the laser light for recording writing units Di other than the both edges; in Mathematical Formula 2, Xo is a ratio (Lo/Wi) of an overlapped width Lo of the writing units Do at the both edges constituting the solid image and the writing units Di adjacent to the both edges but other than the both edges along the main-scanning direction to a line width Wi of the writing units, which constitute the solid image and adjacent to the both edges, along the main-scanning direction; and in Mathematical Formula 3, Xi is a ratio (Li/Wi) of an overlapped width Li of the adjacent writing units Di, which constitute the solid image and are other than the both edges, along the main-scanning direction, to the line width Wi of the adjacent writing units Di, which constitute the solid image and are other than the both edges, along the main-scanning direction.

3. The recording method according to claim 1,
wherein the writing units constituting the solid image are a combination of writing units Dn recorded with reducing irradiation energy of the laser light stepwise in a certain region from the both edges towards a center direction in the main-scanning direction, where n is 1 at writing units present at the both edges relative to the main-scanning direction, followed by an integer from 2 and larger as coming close to the center direction; and writing units Dj positioned closer to a side of the center than the writing units Dn, and irradiation energy of laser light for recording the writing units Dn is larger than irradiation energy of laser light for recording the writing units Di.

4. The recording method according to claim 3,
wherein the writing units constituting the solid image satisfy all of a relationship represented by Mathematical Formula 4 below, a relationship represented by Mathematical Formula 5 below, and a relationship represented by Mathematical Formula 6 below,
1.0<Z<2.0 Mathematical Formula 4
0<Xn<0.6 Mathematical Formula 5
0<Xj≦0.4 Mathematical Formula 6
where, in Mathematical Formula 4, Z is a ratio (E1/Ej) of an irradiation energy value E1 of the laser light for recording writing units Dn (n is 1) present at the both edges of the solid image relative to the main-scanning direction to an irradiation energy value Ej of laser light for recording the writing units Dj; in Mathematical Formula 5, Xn is a ratio (Ln/Ws) of an overlapped width Ln of the writing unit Dn and the writing unit Ds to a line width Ws of a writing unit Ds adjacent to the writing unit Dn at a side of a center relative to the main-scanning direction, where n in Xn is identical to n in the writing unit Dn; and in Mathematical Formula 6, Xj is a ratio (Lj/Wj) of an overlapped width Lj of the main writing units Dj along the main-scanning direction to a line width Wj of the main writing unit Dj along the main-scanning direction.

5. The recording method according to claim 1,
wherein a minimum distance between centers of the optical fibers is 1.0 mm or less.

6. The recording method according to claim 1,
wherein the number of the optical fibers aligned in the optical fiber array is 10 or greater.

7. The recording method according to claim 1,
wherein the recording target is a thermosensitive recording medium, a structure including a thermosensitive recording area, or both.

8. The recording method according to claim 1,
wherein the emitting laser light to the recording target to record an image is performed, while the recording target is conveyed by a recording target-conveying unit that is configured to convey the recording target.

9. A recording device comprising:
a plurality of laser light-emitting elements; and
an emitting unit including an optical fiber array, in which a plurality of optical fibers configured to guide laser light emitted from the laser light-emitting elements are aligned,
wherein the recording device is configured to apply laser light emitted from the optical fiber array with moving a recording target and the optical fiber array relatively, to record an image formed of writing units,
wherein, in a case where the laser light is applied from the optical fibers adjacent to each other in a main-scanning direction to the recording target to record a solid image formed of the writing units at least partially overlapped to each other in the main-scanning direction,
recording is performed by reducing irradiation energy of the laser light for recording the writing units other than both edges of the solid image relative to the main-scanning direction, compared to irradiation energy of the laser light for recording the writing units present at the both edges of the solid image.

10. The recording device according to claim 9,
wherein the writing units constituting the solid image satisfy all of a relationship represented by Mathematical Formula 1 below, a relationship represented by Mathematical Formula 2 below, and a relationship represented by Mathematical Formula 3 below,
1.0<Y<2.0 Mathematical Formula 1
0<Xo<0.6 Mathematical Formula 2
0<Xi≦0.4 Mathematical Formula 3
where, in Mathematical Formula 1, Y is a ratio (Eo/Ei) of irradiation energy Eo of the laser light for recording writing units Do present at the both edges of the solid image relative to the main-scanning direction to irradiation energy Ei of the laser light for recording writing units Di other than the both edges; in Mathematical Formula 2, Xo is a ratio (Lo/Wi) of an overlapped width Lo of the writing units Do at the both edges constituting the solid image and the writing units Di adjacent to the both edges but other than the both edges along the main-scanning direction to a line width Wi of the writing units, which constitute the solid image and adjacent to the both edges, along the main-scanning direction;
and in Mathematical Formula 3, Xi is a ratio (Li/Wi) of an overlapped width Li of the adjacent writing units Di, which constitute the solid image and are other than the both edges, along the main-scanning direction, to the line width Wi of the adjacent writing units Di, which constitute the solid image and are other than the both edges, along the main-scanning direction.

11. The recording device according to claim 9,
wherein the writing units constituting the solid image are recorded by reducing irradiation energy of the laser light stepwise in a certain region from the writing units present at both edges towards the writing units present at a center direction along the main-scanning direction, and in the region, the irradiation energy of the laser light for recording the writing units at the center direction is lower than the irradiation energy for laser light for recording the writing units at the both ends by 1% or greater but 30% or less.

12. The recording device according to claim 11,
wherein the writing units constituting the solid image satisfy all of a relationship represented by Mathematical Formula 4 below, a relationship represented by Mathematical Formula 5 below, and a relationship represented by Mathematical Formula 6 below,
1.0<Z<2.0 Mathematical Formula 4
0<Xn<0.6 Mathematical Formula 5
0<Xj≦0.4 Mathematical Formula 6
where, in Mathematical Formula 4, Z is a ratio (E1/Ej) of an irradiation energy value E1 of the laser light for recording writing units Dn (n is 1) present at the both edges of the solid image relative to the main-scanning direction to an irradiation energy value Ej of laser light for recording the writing units Dj; in Mathematical Formula 5, Xn is a ratio (Ln/Ws) of an overlapped width Ln of the writing unit Dn and the writing unit Ds to a line width Ws of a writing unit Ds adjacent to the writing unit Dn at a side of a center relative to the main-scanning direction, where n in Xn is identical to n in the writing unit Dn; and in Mathematical Formula 6, Xj is a ratio (Lj/Wj) of an overlapped width Lj of the main writing units Dj along the main-scanning direction to a line width Wj of the main writing unit Dj along the main-scanning direction.

13. The recording device according to claim 9,
wherein a minimum distance between centers of the optical fibers is 1.0 mm or less.

14. The recording device according to claim 9,
wherein the number of the optical fibers aligned in the optical fiber array is 10 or greater.

15. The recording device according to claim 9,
wherein irradiation power of the laser light is controlled depending on a temperature of the laser light-emitting element.

16. The recording device according to claim 9,
wherein the recording target is a thermosensitive recording medium, a structure including a thermosensitive recording area, or both.

17. The recording device according to claim 9, further comprising a recording target-conveying unit that is configured to convey the recording target,
wherein laser light is applied to the recording target to record an image while conveying the recording target by the recording target-conveying unit.
